(19) United States
(12) Patent Application Publication
(10) Pub. No.: US 2010/0023425 A1
(43) Pub. Date: Jan. 28, 2010

(54) System, Method and Apparatus for Geographical Restriction of Offers for Sale

(75) Inventors: William Pat Price, Rhome, TX (US); Timothy Elliott, Huntington Beach, CA (US); Marcus P. Apitz, Yorba Linda, CA (US)

Correspondence Address: Law Office of Scott C Harris Inc, PO Box 1389, Rancho Santa Fe, CA, 92067, US

(73) Assignee: VIZIO, INC, Irvine, CA (US)

(21) Appl. No.: 12/180,472

(22) Filed: Jul. 25, 2008

(51) Int. Cl. G06Q 30/00; G06F 17/30

(52) U.S. Cl. 705/27; 707/5; 707/E17.109

(57) ABSTRACT

An application for a method of presenting items of a catalog in various geographic regions includes providing a catalog of items, each item having associated therewith at least one geographic code. A search term and a geographic location are provided. The catalog is searched for matching items that are related to the search term and in which the geographic code indicates the item is suitable for the geographic location.

### BACKGROUND

This invention relates to the field of sales and more particularly to a system, method and apparatus for restricting sales of certain items to certain geographic boundaries.

### DESCRIPTION OF THE RELATED ART

Recently, Internet sales have become a way of life. Internet sales offer a certain amount of convenience coupled with a huge amount of variety and competition, all good for the consumer. Several businesses such as Amazon.com have emerged as entirely Internet sales companies, while others such as Barnes and Nobles have paralleled their brick and mortar business with Internet web sites that sell much of the same products as available in their brick and mortar stores. Today, it is almost impossible to find a brick and mortar store that doesn't also have a web site to offer Internet sales.

The Internet is an international network permitting sales of products nation-wide as well as world-wide. A store located in New York City is able to sell its products to a customer in California, Hawaii, Japan, South Africa, etc. Credit card companies help enable this by automatically providing currency exchange on sales made with their credit cards. Unfortunately, what is good for one is not always good for all. Some goods and services that that are totally acceptable in one place are unacceptable in another. In some cases, some goods and service are legal in one place and illegal in others. Presently, companies offering products for sale over the Internet prevent goods having objectionable content from being shipped to locations in which such goods are unacceptable, deemed immoral or illegal. This method helps prevent objectionable material from entering locations in which it is objectionable, but frustrates the purchaser and requires the merchant to refund monies already collected.

Furthermore, in some communities, the descriptions and images of the products being offered are objectionable or even illegal.

In another existing method, Internet sales software require a customer enter or store their shipping information and, when a shopping cart contains such objectionable material, the software prevents continuing the checkout process until the objectionable material is removed. This method is an improvement over the last, but has one major problem. Often, pictures of items are displayed on Internet sales web sites and the pictures of the items are banned, illegal or immoral in certain locations. Therefore, in some examples, an Internet sales site catering to the norms of one country breaks the laws of another country. In another example, an Internet sales site located in one state of one country breaks the laws of another state within the same country.

What is needed is a system that will provide offers for sale of certain products/services to geographic regions that allow such products/services and restrict such offers to geographic regions that ban such products/services.

### SUMMARY

In one embodiment, a method of presenting items of a catalog in various geographic regions is disclosed including providing a catalog of items, each item having associated therewith at least one geographic code. A search term and a geographic location are provided. The catalog is searched for matching items that are related to the search term and in which the geographic code indicates the item is suitable for the geographic location.

In another embodiment, a system for presenting items of a catalog is disclosed including a server interfaced to a network and a terminal connected to the server through the network. A catalog of items is interfaced to the server. Each item has associated therewith at least one geographic code. A software module running on the server accepts a search term from the terminal and determines the geographic location of the terminal. A second software module running on the server searches the catalog for matching items that are related to the search term and in which the geographic code indicates the item is suitable for the geographic location.

In another embodiment, an apparatus for presenting a catalog is disclosed including a server computer, a terminal and a database interfaced to the server computer. The database includes records, each having a fields and one of the fields including a geographic field. Search software running on the server computer communicates with the terminal and obtains a geographic location of the terminal. The search software receives catalog search requests from the terminal and responsive to the search requests, searches the database to find resulting records related to the search request and absent of objectionable material then sends remaining resulting records to the terminal. The objectionable material is material in which the geographic field contains the geographic location.

In another embodiment, a computer program runs on a programmed computer for accessing a catalog from a remote terminal is disclosed including computer usable medium having computer-readable code embodied in the medium, the computer-readable code including code for reading an IP address of the remote terminal, code for accepting a search request from the remote terminal, code for translating the IP address into a geographic address, code for finding appropriate items in a catalog related to the search request and code for sending the appropriate items to the remote terminal.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a schematic view of a system of the present invention.

FIG. 2 illustrates a first flow chart of the present invention.

FIG. 3 illustrates a second flow chart of the present invention.

FIG. 4 illustrates an exemplary data record of the present invention.

FIG. 5 illustrates an exemplary location mapping table of the present invention.

FIG. 6 illustrates a third flow chart of the present invention.

FIG. 7 illustrates an exemplary user interface of the present invention.

FIG. 8 illustrates the exemplary user interface of the present invention as used in a second geographic region.

FIG. 9 illustrates an exemplary computer system of the present invention.

### DETAILED DESCRIPTION

Reference will now be made in detail to the presently preferred embodiments of the invention, examples of which are illustrated in the accompanying drawings. Throughout the following detailed description, the same reference numerals refer to the same elements in all figures.

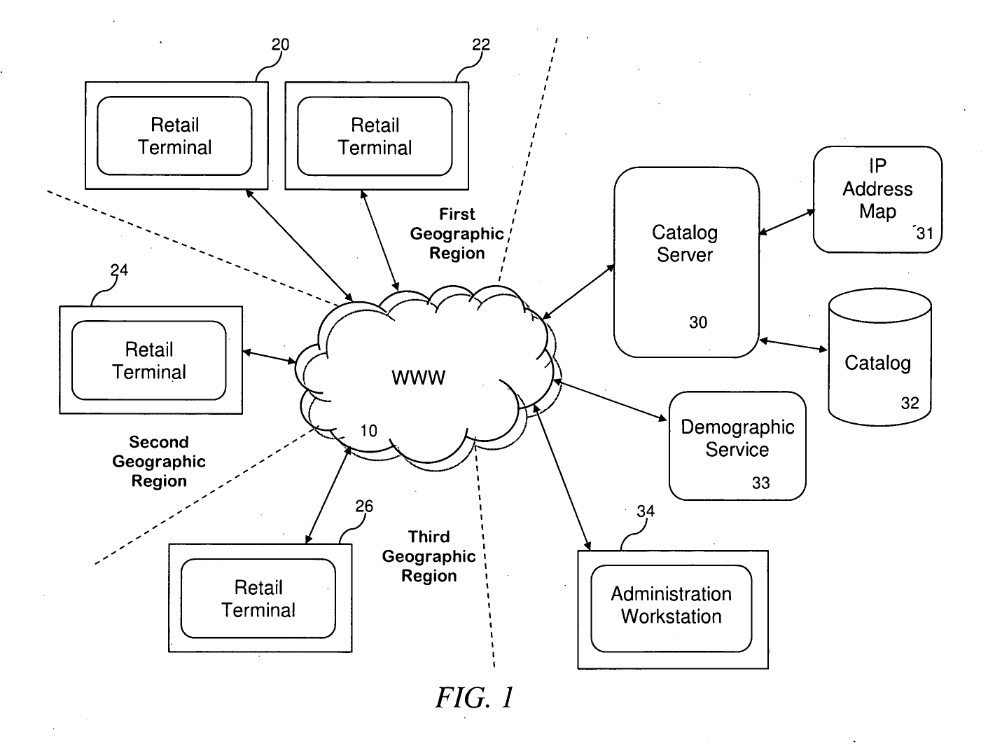

Referring to FIG. 1, a schematic view of a system of the present invention is shown. The Internet 10 (or any wide-area public network of any name) is an ever increasing source of revenues for many retail companies. Consumers from every part of the world have access to even the smallest retail store as long as it has a presence on the Internet 10. Consumers or shoppers use a terminal device 20/22/24/26 of many types to access the Internet 10. Examples of these terminal devices 20/22/24/26 are personal computers, personal digital assistants (PDA), web-enabled cell phones, wireless terminal devices (e.g., Blackberry) and the like. For simplicity, the terminal devices 20/22/24/26 of FIG. 1 are shown as personal computers in three geographic regions. It is known that there are many geographic regions related to countries, states (other countries have different names for states such a prefectures), cities, towns, counties, etc. In the example of FIG. 1, only three geographic regions are shown for simplicity purposes. The first geographic region has two terminal devices 20/22, although any number is possible. The second geographic region has one terminal device 24 and the third geographic region also has one terminal device 26, again, any number of terminal devices is anticipated. All terminal devices 20/22/24/26 are configured to access a catalog server 30 through the Internet 10.

To best describe the operation of the present invention, let the first geographic region be California (CA), the second geographic region be Mississippi (MS) and the third geographic region be three states including Alabama (AL), Kansas (KS) and Mississippi (MS).

The catalog server 30 of the embodiment presents offers for presentation and/or sale various products and/or services. Examples of such are music, movies, electronic goods, escort services etc. The consumer/shopper browses an online catalog 32 viewing the products and/or services available. In some catalogs 32, descriptions of the products/services are available. In some catalogs 32 other information regarding the products/services is available including but not limited to pictures, pricing, shipping information and samples (e.g., music or video segments), for example. Typically, the customer/shopper enters a search term or search request into a data entry screen running within a browser, the browser operating on the customer/shopper's terminal device 20/22/24/26. The search term is sent to the server to locate products/services from the catalog that are related to the search term. For example, a search term contains a color finds items in the catalog that have an attribute of the same color, etc.

Typically, the customer/shopper selects one or more items found and the items are placed in a virtual shopping cart. When finished, the shopper/customer checks out by supplying their credit card or other payment (e.g., Paypal). In some embodiments, the purchased goods are sent to the shopper by a shipping method such as the U.S. Post Office, UPS, FEDEX, etc. In other embodiments, the purchased goods are downloaded to the user. In the later embodiment, the purchased goods are soft goods such as music, movies, software, forms, contracts, etc.

In some embodiments, the server 30 obtains a geographic location of the user 20/22/24/26 using an IP address map 31. In some embodiments, the IP address map 31 is a database or table indexed by IP address. A Search for an IP address in the IP address map 31 results in matching records containing the address of the desired IP address. The IP address map 31 translates the IP address of the user computer 20/22/24/26 into a geographic location (e.g., latitude/longitude, street address, etc.). If the IP address map 31 fails or if the server 30 cannot obtain a valid IP address of the user computer 20/22/24/26, the geographic location is set to a default location that is the lowest common denominator (no objectionable material is provided).

In other embodiments, the server 30 obtains a geographic location of the user 20/22/24/26 using an external service shown as the Demographic Service 33. In such, the server 30 sends a transaction to the Demographic Service 33 through the Internet 10 and the Demographic Service 33 returns the geographic location of the IP address.

Translation of an IP address into a geographic location

is known in the industry as evidenced by companies such as LiveIPMap (http://www.liveipmap.com/) and GeoBytes (http://www.geobytes.cm/ipLocator.htm).

In this example, the catalog 32 is administered by a person from an administration terminal 34 as known in the industry. This person is responsible for, among other things, setting up the overall geographic strategy and tables, and assigning geographic regions to products in the catalog 32.

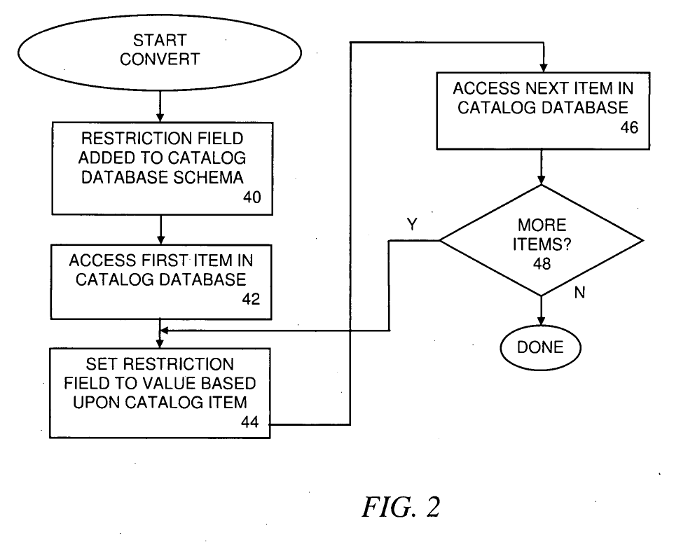

Referring to FIG. 2, a first flow chart of the present invention is shown. This method is an example of converting a typical catalog database into a catalog database of the present invention. The method begins with adding a restriction field to the catalog database schema 40. Various ways are known in the industry for adding fields to a catalog, all of which are included here within. Alternately, a parallel database (not shown) is possible containing the restriction data. Once the new field is created, it must be set or populated for each item in the catalog that has a geographic restriction. This is done by (a) accessing the first item in the catalog database 42 then (b) setting the restriction field to the desired values (e.g., restriction code or geographic code) based upon the current catalog item 44. In some embodiments, the restriction field is set to the locations in which the item is restricted (e.g., “AL, KS, MS”) while in other embodiments, the restriction field is set to a value (e.g., restriction code or geographic code) indicating one or more geographic locations (e.g., 45). Next, (c) the next item in the database is accessed 46. (d) If there are more items 48, steps (b) through (d) are repeated until there are no more items in the catalog database 48. It is anticipated that some geographic code fields are empty and, in such, the related item is either viewable in all geographic locations or restricted from view in all geographic locations that have any sort of restriction.

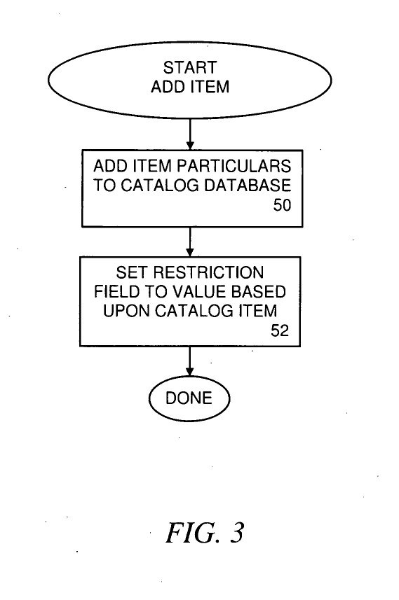

Referring to FIG. 3, a second flow chart of the present invention is shown. This is an example of adding an item to a catalog 32 which already has provisions for geographic restrictions. In this, the item is added to the catalog 32 as known in the industry 50; for example, entering a title, description, price, photograph, search keywords, etc. Next, a restriction value (e.g., geographic code) is added based upon the nature of the item 52. In some embodiments, an empty restriction value represents “unrestricted.”

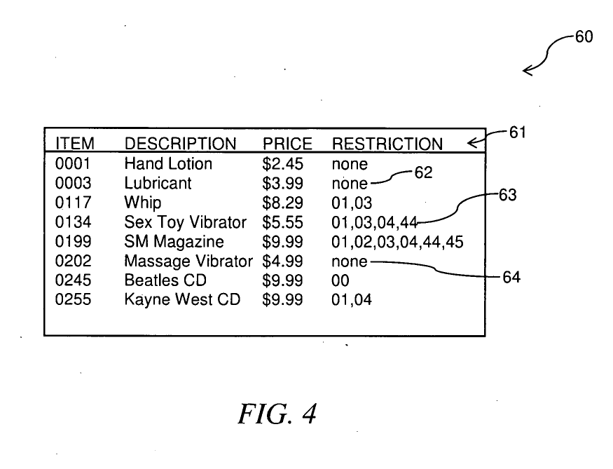

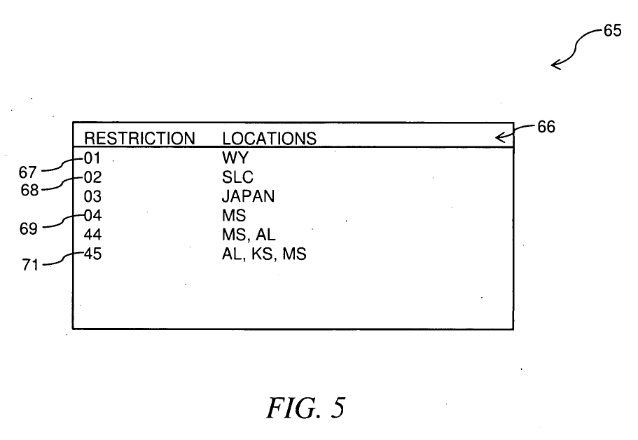

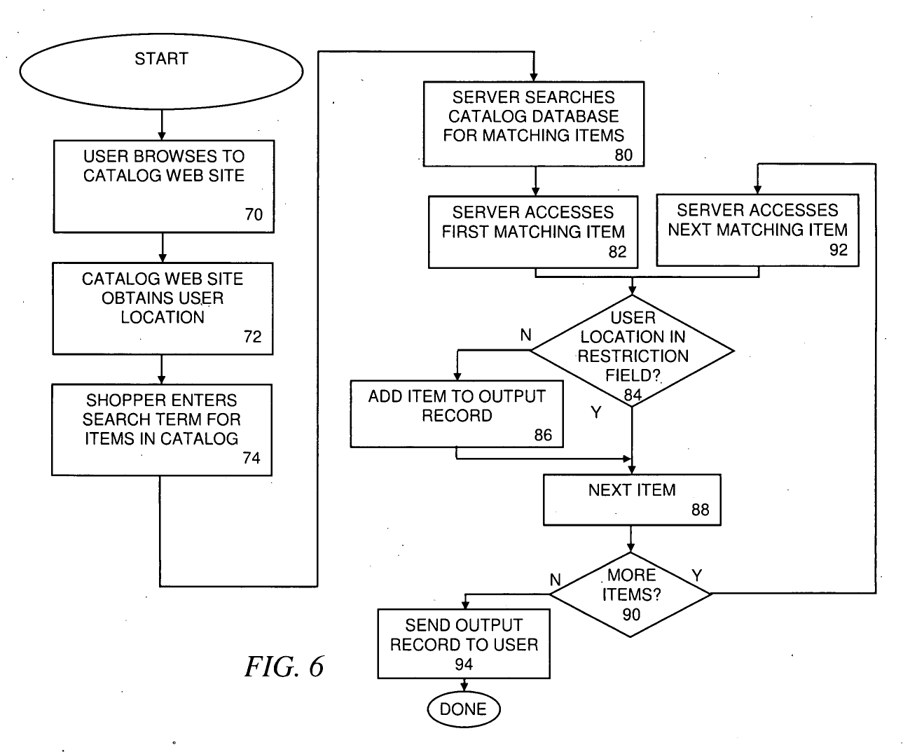

Referring to FIG. 4, an exemplary data record of the present invention is shown. In this greatly reduced content and schema 60 of a typical catalog 32, the heading line 61 includes names of some fields of a catalog database 32 such as an item code, description, price and, according the present invention, a restriction field. Each subsequent line represents one item in the catalog, for example, item 0003 is a lubricant priced at $3.99 and has a geographic restriction code of “none” 62. Item 0134 is for a sex toy and is restricted 63 in geographic locations 01, 03, 04 and 44. Item 202 is a massage vibrator and is not restricted 64. In some embodiments, the geographic restrictions are numerically coded as shown in FIG. 5 and a table such as in FIG. 6 is used to translate the coding into a country, a state, a county, a city, a town, a prefecture, a ward, a set of coordinates, etc. In other embodiments, one or more geographic restriction codes are stored within each item record in the catalog database 32. For example, if the item was not allowed to be sold or shown in Mississippi and Georgia, then the restriction field is “MS, GA.”

Referring to FIG. 5, an exemplary location mapping table of an embodiment is shown. This table 65 is a typical example of a mapping table used to map restrictions as shown in FIG. 5 into geographic locations. In this greatly simplified example, the mapping table 65 has a column for restrictions (codes) and a column for locations (states, cities or countries in this example) shown in the title or schema row 66. For example, the restriction code 01 represents a single state, Wyoming 67, the restriction code 02 represents a single city, Salt Lake City 68 and the restriction code 03 represents a single country, Japan 69. In some embodiments, a restriction code maps to multiple geographic locations having similar restrictions such as the restriction code 45 mapping to Alabama, Kansas and Oklahoma 71.

Referring to FIG. 6, a third flow chart of an embodiment is shown. It is well known in the industry to present shoppers/customers with a searchable catalog through the Internet, whereby shoppers are provided with search tools to find items of interest and, for each item found, the shoppers are provided with descriptions, photographs, pricing, etc. Prior to the present invention, all shoppers saw all items irrespective of the location of the shopper and the laws and social norms governing the individual shopper. The present invention utilizes knowledge of the shopper's location to determine which items are returned by the search tool and, therefore, which items are viewable and hence, which items are available to be ordered by that shopper.

The method begins with the shopper browsing to the catalog web site 70. Upon access of the catalog web site, the server providing the catalog (or surrogate) obtains the shopper's geographic location 72. The geographic location is determined in a manner that is not easily forged. In one embodiment, the shopper provides their address when accessing the catalog or in a profile that is maintained for the customer. This method is not as fool proof in that it depends upon the truthful entry by the customer. It is also not effective for a shopper that has recently moved from one geographic location with one set of laws/norms to another that has a different set of laws/norms. In another embodiment, the shopper provides an address, preferably in a profile, that is confirmed by various means such as credit card verification. Still, this means of verification is not foolproof since the credit card billing address is sometimes different than the location of the shopper such as a shopper that lives in the USA and is traveling to a foreign country and shopping from that country.

In another embodiment, the geographic location is obtained 72 through a query of the shopper's Internet Protocol Address using, for example, a map internet address function. In such, the server 30 reads the IP address of the shopper's computer and provides it to the IP Address Map service 31 or a local IP address map function as known in the industry. The IP Address Map service 31 or a local IP address map function returns a geographic address (e.g., latitude/longitude, street address, etc.)

In most instances, the shopper's IP address is fixed and relates to a physical location is a specific geographic region. As previously stated, translating of an IP address into a geographic location is known in the industry. In some instances, the shopper is using a mobile device such as a PDA, Blackberry, etc. and such device is capable of being used on boundaries between geographic locations. For example, a mobile cell phone used to access a catalog of the present embodiment is used in northern Kentucky but serviced by a cell site in Cincinnati Ohio. In such instances, the present embodiment restricts the catalog based upon a union of the two (multiple) geographic possibilities, thereby prohibiting view of items restricted in either geographic location. Is some circumstances, the IP address map function cannot translate the IP address into a geographic location or the server 30 cannot obtain a valid IP address of the shopper's computer. In such, the geographic location is set to a default location that includes all restrictions possible (e.g., no objectionable material is presented).

Once the location is obtained, the shopper enters search terms for items of interest 74 in the catalog 32. The search terms are processed by the server 30, which searches the catalog 32 for matching items 80. There are many ways to perform such a search known in the industry including adding the geographic location to the search terms, thereby the search engine will not return items having such geographic restriction codes matching the geographic location, etc. The example shown in FIG. 6 is only an example to show one method of filtering the items of the catalog 32 such that items that are restricted in the shopper's geographic location are not presented to the shopper for view and/or ordering.

The server 30 accesses the first matching item 82. (a) Next, the server 30 determines if the shopper's geographic location is contained within the geographic restriction field 84. For example, in the tables of FIGS. 4 and 5, if the item is 0134 (the sex toy vibrator) and the shopper is in Wyoming, Wyoming translates to restriction 01 as in the location translation table 66 and item 0134 includes 01 in the restriction 63 for the item 134, therefore, the shopper's geographic location is in the geographic restriction field for this item. Only if the shopper's location is not in the geographic restriction field 84, is the item added to the output record 86, resulting in only items without restrictions for the shopper's geographic location appearing in the output record.

The next item in the search results is accessed 88 and if there are more items 90, the previous steps starting with (a) are repeated to determine if that item should be added to the output record and, if so, added. If no more items are left in the search results 90, the output record is sent to the shopper 94.

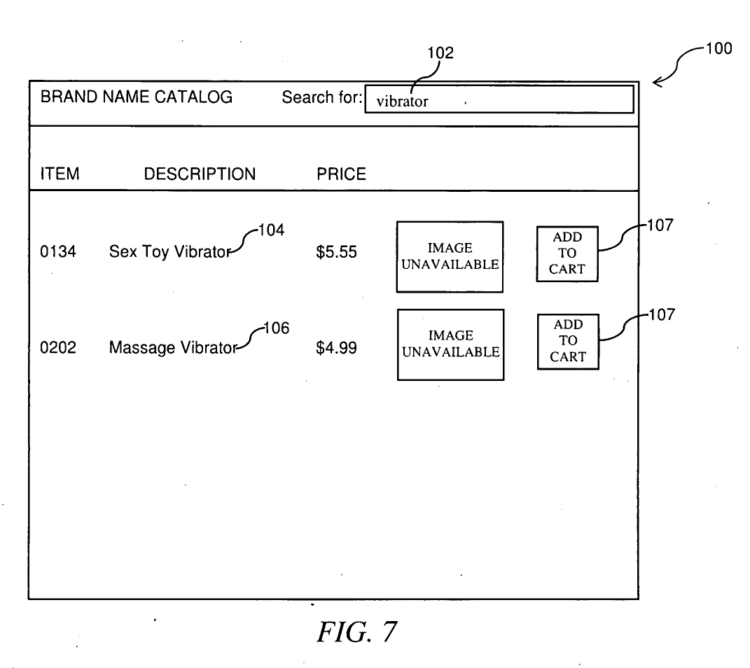

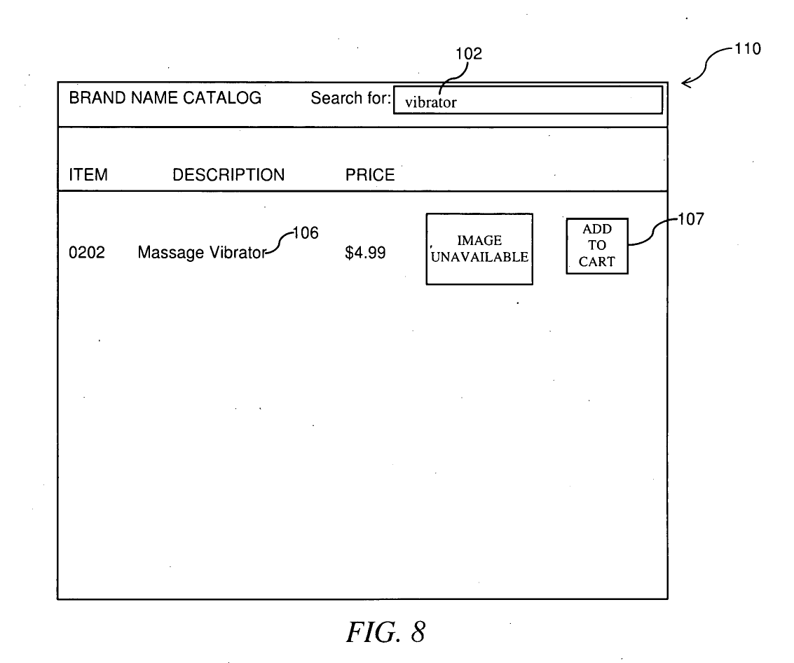

Referring to FIG. 7, an exemplary user interface of the present embodiment is shown. In reference to FIGS. 7 and 8, assume the shopper of FIG. 7 is in California and the shopper of FIG. 8 is in Wyoming. Wyoming translates (FIG. 4) to restriction 01. A search of the sample catalog 60 for “vibrator” returns items 0134 and 0202, of which item 0134's restriction includes Wyoming 63 (01). In this example, a shopper 20 from a first geographic location has displayed a catalog screen 100 within their browser as known in the industry. In FIG. 7, the shopper from California has entered a search term “vibrator” 102. Since there are not restrictions on residents of California for either item 0134 or item 0202, a display of both items 104/106 is made. An offer for sale 107 is also made for both items. In some embodiments, if an item is restricted, it is not displayed to a user in the restricted geographic location. In some embodiments, an item is permitted to be described, but is not allowed to be sold in certain geographic locations and, therefore, the item is displayed 104/106, but not offered for sale 107.

In some embodiments, there are multiple geographic restriction fields in the catalog 32. For example, one geographic restriction field for the description, one geographic restriction field for the images/pictures and one geographic restriction field for the offer for sale. In such, some items may be described, but not offered for sale, etc.

Referring now to FIG. 8, the exemplary user interface of the present embodiment as used in a second geographic region (Wyoming) is shown 110. As in FIG. 7, the shopper from Wyoming

has entered a search term “vibrator” 102. Since residents of Wyoming are restricted from viewing item 0134, only the massage vibrator (items 106) is displayed. An offer for sale 107 is also made for both the massage vibrator 107.

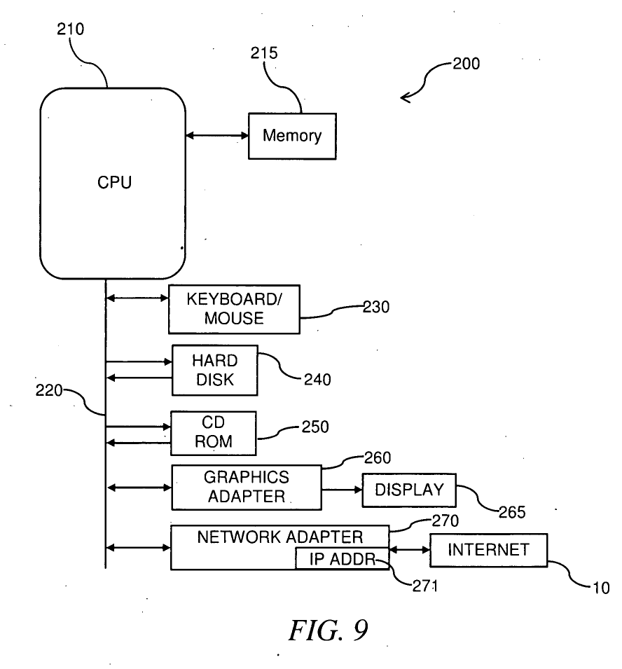

Referring to FIG. 9, an exemplary computer system of the present embodiment is shown. Although shown in its simplest form, having a single processor, many different computer architectures are known that accomplish similar results in a similar fashion and the present invention is not limited in

any way to any particular computer system. The present invention works well utilizing a single processor system as shown in FIG. 9, a multiple processor system where multiple processors share resources such as memory and storage, a

multiple server system where several independent servers operate in parallel (perhaps having shared access to the data or any combination. In this, a processor 210 is provided to execute stored programs that are generally stored for execution within a memory 215. The processor 210 can be any

processor or a group of processors, for example an Intel Pentium-4® CPU or the like. The memory 215 is connected to the processor and can be any memory suitable for connection with the selected processor 210, such as SRAM, DRAM, SDRAM, RDRAM, DDR, DDR-2, etc.

Also connected to the processor 210 is a system bus 220 for connecting to peripheral subsystems such as a network interface 270 with an IP Address 270, a hard disk 240, a CDROM 250, a graphics adapter 260 and a keyboard/mouse 230. The graphics adapter 260 receives commands and display information

from the system bus 230 and generates a display image that is displayed on the display 265.

In general, the hard disk 240 may be used to store programs, executable code and data persistently, while the CDROM 250 may be used to load said programs, executable code and data from removable media onto the hard disk 240. These peripherals are meant to be examples of input/output devices, persistent storage and removable media storage. Other examples of persistent storage include core memory, FRAM, flash memory, etc. Other examples of removable media storage include CDRW, DVD, DVD writeable, compact flash, other removable flash media, floppy disk, etc. In some embodiments, other devices are connected to the system through the system bus 230 or with other input-output connections. Examples of these devices include printers; graphics tablets; joysticks; and communications adapters such as modems.

The network interface 270 connects the computer-based system to the Internet 10 through a link which is, preferably, a high speed link such as a cable broadband connection, a Digital Subscriber Loop (DSL) broadband connection, a T1 line or a T3 line.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A method of presenting items of a catalog in various geographic regions, the method comprising:
using a computer for providing a catalog of items, each item having associated therewith at least one geographic code;
receiving a search term and a geographic location in said computer;
searching the catalog for matching items that are related to the search term and in which the geographic code indicates the item is suitable for the geographic location.

2. The method of claim 1, wherein said geographic location is received from a user.

3. The method of claim 1, wherein said receiving the geographic location includes retrieving an IP address of a user terminal and translating the IP address into information indicative of the geographic location.

4. The method of claim 3, where in said translating the IP address into the geographic location includes using an IP Address Map function.

5. The method of claim 1, wherein said searching the catalog includes retrieving a set of items related to the search term from the catalog and filtering the set of items to remove objectionable items, the filtering based upon the geographic location and the geographic codes associated with the items.

6. The method of claim 1, wherein each of the at least one geographic codes translates into a location selected from the group consisting of a country, a state, a county, a city, a town, a prefecture, a ward and a set of coordinates.

7. An apparatus comprising:
a server, including a network connection structure;
said server storing a catalog of items, each item having associated therewith at least one geographic code;
a software module running on the server,
accepting a search term from terminal user, the software module determining a geographic location of the terminal and
using said search term to search the catalog for matching items that are related to the search term and using the geographic code to indicate whether the item is suitable for the geographic location.

8. The system of claim 7, whereas the software module is responsive to a manual entry of the geographic location by a user of the terminal.

9. The system of claim 7, whereas the software module retrieves an IP address of a terminal and translating the IP address into the geographic location.

10. The system of claim 9, further comprising an IP Address Map function and wherein said software module uses said IP address function.

11. The system of claim 7, wherein said software module retrieves a set of items related to the search term from the catalog and filters the set of items and removes objectionable items based upon the geographic location and the geographic codes associated with the items in the set of items, and returns results based on said filters and removes.

12. The system of claim 7, whereas each of the at least one geographic codes translates into a location selected from the group consisting of a country, a state, a county, a city, a town, a prefecture, a ward and a set of coordinates.

13. An apparatus for presenting a catalog, the apparatus comprising:
a server computer;
a database interfaced to the server computer, the database comprising a plurality of records, each of the records having a plurality of fields, the fields including a geographic field;
search software running on the server computer, the search software receiving a request, the search software adapted to obtain a geographic location from which the request is originated, and to search the database to find resulting records related to the search request and to remove objectionable material, and to send said resulting records with said objectionable material removed to the terminal;
whereas objectionable material is that in which the geographic field contains the geographic location.

14. The apparatus of claim 13, whereas the search software obtains the geographic location of the terminal as manually entered data.

15. The apparatus of claim 13, wherein the search software obtains the geographic location of the terminal by retrieving an IP address of a terminal and translating the IP address into the geographic location.

16. The apparatus of claim 15, wherein the translating of the IP address into the geographic location includes using an IP Address Map function.

17. The apparatus of claim 13, whereas each of the at least one geographic codes translates into a location selected from the group consisting of a country, a state, a county, a city, a town, a prefecture, a ward and a set of coordinates.

18. A computer readable medium encoded with a computer program to cause a machine to
access a catalog
determine an IP address of a remote terminal;
accepting a search request;
translating the IP address of the remote terminal into a geographic address;
find appropriate items in a catalog related to the search request; and
sending the appropriate items to the remote terminal.

19. The medium of claim 18, wherein said find appropriate items uses the geographic address and a geographic field in the catalog to determine the appropriate items.

20. The medium of claim 18, wherein said translating uses an IP mapping function to translate the IP address of the remote terminal into a geographic address of the terminal.

21. The medium of claim 18, wherein the geographic address is selected from the group consisting of a country, a state, a county, a city, a town, a prefecture, a ward and a set of coordinates.
